(19) United States
(12) Patent Application Publication
(10) Pub. No.: US 2018/0183180 A1
(43) Pub. Date: Jun. 28, 2018

(54) LEVER-TYPE CONNECTOR

(71) Applicant: DAI-ICHI SEIKO CO., LTD., Kyoto-shi (JP)

(72) Inventors: Takayoshi Endo, Shizuoka-shi (JP); Yoshimitsu Hashimoto, Onojo-shi (JP); Hiromichi Ide, Onojo-shi (JP)

(21) Appl. No.: 15/845,512

(22) Filed: Dec. 18, 2017

(30) Foreign Application Priority Data
Dec. 27, 2016 (JP) 2016-254001

(51) Int. Cl. H01R 13/629; H01R 9/24

(52) U.S. Cl. CPC H01R 13/62938; H01R 9/2408; H01R 13/62905; H01R 13/6295; H01R 13/62955; H01R 9/2491

(57) ABSTRACT

A lever-type connector includes first and second connectors, and a lever member. The first connector includes a cam pin. The second connector is connected to a cable and is fitted to the first connector. The lever member includes a body and an operating part, where a cam groove into which the cam pin is inserted is formed in the body, and the operating part is contiguous to the body and is used for performing a rotating operation. The lever member is rotatably attached to the second connector and causes the first connector and the second connector to be fitted together by rotating from an initial position to a final fitting position. When the lever member is rotated, a tip of the operating part moves through a space (situated on the cable side with respect to a front face of the second connector) from which the cable is led out.

### CROSS-REFERENCE TO RELATED APPLICATION

This application claims the benefit of Japanese Patent Application No. 2016-254001, filed on Dec. 27, 2016, the entire disclosure of which is incorporated by reference herein.

### FIELD

This application relates to a lever-type connector.

### BACKGROUND

Patent Literature 1 and 2 listed below each disclose a connector in which one connector is fitted into the other connector by preliminarily engaging the one connector with the other connector and then operating a lever.

Patent Literature 1 Unexamined Japanese Utility Model Application Kokai Publication No. H5-36775

Patent Literature 2 Unexamined Japanese Patent Application Kokai Publication No. 2011-216441

In the lever-type connectors described in Patent Literature 1 and 2, another member may be disposed on a path of the lever depending on the environment where the lever-type connector is installed. If this is the case, the lever-type connector is problematic because such another member interferes with the lever, causing difficulty in operating the lever.

The present disclosure has been created under the aforementioned circumstances, and an objective of the disclosure is to provide a lever-type connector that allows for easy lever operations for fitting, irrespective of the environment where the lever-type connector is installed.

### SUMMARY

To achieve the aforementioned objective, a lever-type connector according to the present disclosure includes:

a first connector that includes a cam pin;

a second connector that is connected to an electric wire and is fitted to the first connector; and

a lever member that includes:
a body in which a cam groove is formed, wherein the cam pin is to be inserted into the cam groove; and
an operating part that is contiguous to the body and is intended for performing a rotating operation,

wherein the lever member is rotatably attached to the second connector and causes the first connector and the second connector to be fitted together by rotating from an initial position to a final fitting position, and

wherein the operating part is configured so that, when the lever member is rotated, a tip of the operating part moves through a space, which is situated on the electric wire side with respect to an end face of the second connector from which the electric wire is led out.

A slip preventer for preventing a slip may be disposed on at least a tip of the operating part.

The slip preventer may include a plurality of grooves.

The operating part may include:

a base end that protrudes from the body of the lever member; and

a tip that protrudes from the base end in a direction different from a direction in which the base end protrudes.

The body may include:

a first body and a second body, in at least one of which the cam groove is formed; and

a joint that connects the first body and the second body.

The operating part may include:

a first part that extends from the first body; and

a second part that extends from the second body.

The operating part may include:

a part that extends from the first body.

The lever-type connector may include a locking mechanism that includes:

a locking part that is disposed on the joint; and

a locked part that is to be caught by the locking part and is disposed on the second connector.

The lever-type connector may include a locking mechanism that includes:

a locking part that is disposed on the first body; and

a locked part that is to be caught by the locking part and is disposed on the second connector.

The second connector may include a cover that covers the electric wire, and the locked part may be disposed on the cover.

The present disclosure allows for easy lever operations for fitting, irrespective of the environment where the lever-type connector is installed.

### BRIEF DESCRIPTION OF THE DRAWINGS

A more complete understanding of this application can be obtained when the following detailed description is considered in conjunction with the following drawings, in which:

FIG. 1 is an exploded perspective view (part 1) of a lever-type connector according to Embodiment 1 of the present disclosure;

FIG. 2 is an exploded side view of the lever-type connector;

FIG. 3 is an exploded perspective view (part 2) of the lever-type connector;

FIG. 4A is a perspective view of a second connector and a lever member;

FIG. 4B is a perspective view illustrating detachment of a cable cover from the second connector with the lever member removed;

FIG. 5 is a drawing intended to explain the space where a cable is led out;

FIG. 6 is a perspective view of the lever member;

FIG. 7A is a side view (part 1) of the lever member;

FIG. 7B is a side view (part 2) of the lever member;

FIG. 8 is a drawing intended to explain the structure of a cam groove;

FIG. 9 is a plan view of a second connector and a lever member;

FIG. 10 is a cross-sectional view taken along A-A in FIG. 9;

FIG. 11 is a front view intended to explain a state of the lever-type connector being used;

FIG. 12 is a cross-sectional view (part 1) taken along B-B in FIG. 11, intended to explain fitting the first and second connectors together;

FIG. 13 is a cross-sectional view (part 2) taken along B-B in FIG. 11, intended to explain fitting the first and second connectors together;

FIG. 14 is a cross-sectional view (part 3) taken along B-B in FIG. 11, intended to explain fitting the first and second connectors together;

FIG. 15 is a cross-sectional view (part 4) taken along B-B in FIG. 11, intended to explain fitting the first and second connectors together;

FIG. 16 is a cross-sectional view (part 5) taken along B-B in FIG. 11, intended to explain fitting the first and second connectors together;

FIG. 17 is a cross-sectional view of a connector according to a comparative example;

FIG. 18 is a cross-sectional view intended to explain an effect of the lever-type connector according to Embodiment 1;

FIG. 19A is a perspective view of a lever member according to Embodiment 2;

FIG. 19B is a perspective view of a lever member according a variation of Embodiment 2;

FIG. 20A is a perspective view (part 1) of a second connector and a lever member according to Embodiment 3;

FIG. 20B is a perspective view (part 2) of the second connector and the lever member according to Embodiment 3;

FIG. 21 is a perspective view illustrating detachment of a cable cover from the second connector with the lever member removed according to Embodiment 3; and

FIG. 22 is a perspective view of a lever member according to Embodiment 4.

### DETAILED DESCRIPTION

### Embodiment 1

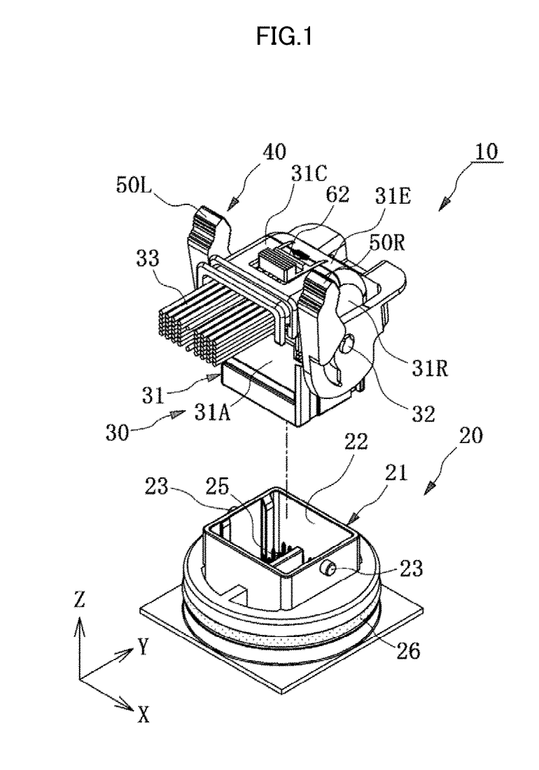

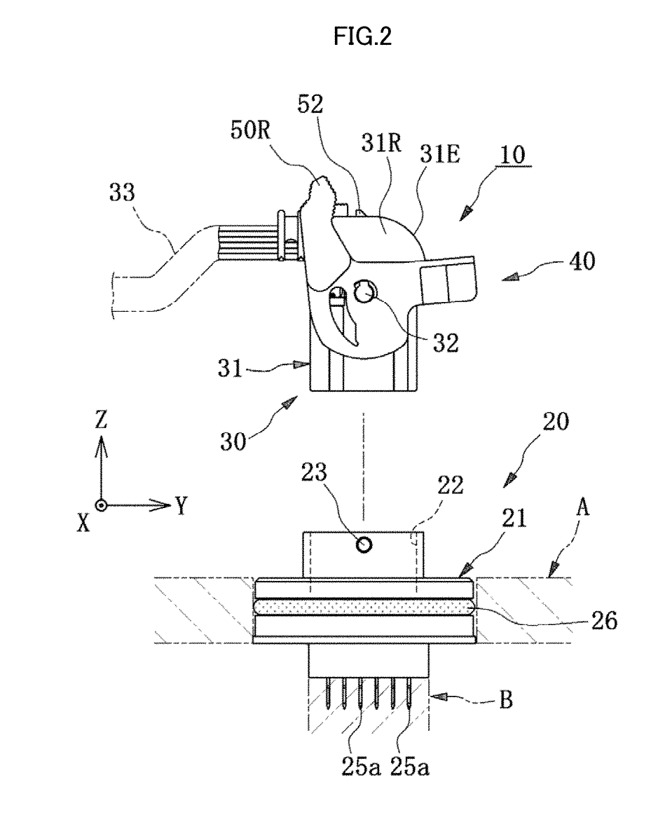

A lever-type connector 10 according to Embodiment 1 of the present disclosure will now be described with reference to FIGS. 1 to 18. For ease of understanding, XYZ coordinates are applied to the figures and referred to as appropriate.

The lever-type connector 10 may be used, for example, for connection between electronic circuit components installed in a car. As illustrated in FIGS. 1 to 3, the lever-type connector 10 includes a first connector 20, a second connector 30, a lever member 40, and a locking mechanism.

In the present embodiment, the first connector 20 includes a male connector. The first connector 20 includes a housing 21 made of an electrically insulative material, a plurality of terminals 25, and an O-ring 26 fitted around the housing 21.

The housing 21 is a member in which a fitting hole 22 open in the+Z direction is formed. The lever-type connector is used with the housing 21 surrounded by, for example, an outer frame A. The second connector 30 is to be inserted into the fitting hole 22 in the housing 21. A cam pin 23 is formed on the wall of the housing 21 on both of the+X and−X sides. The cam pin 23 is formed into a circular cylindrical shape.

The terminals 25 are formed of an electrically conductive material and include male terminals. One end of the terminal 25 on the+Z side is formed to protrude into the fitting hole 22. An end 25a of the terminal 25 on the−Z side is connected to an attachment target B such as a car-mounted component or a wiring substrate.

In the present embodiment, the second connector 30 includes a female connector. The second connector 30 includes a housing 31 having a terminal housing chamber formed inside the housing 31, as well as including a plurality of terminals housed in the terminal housing chamber.

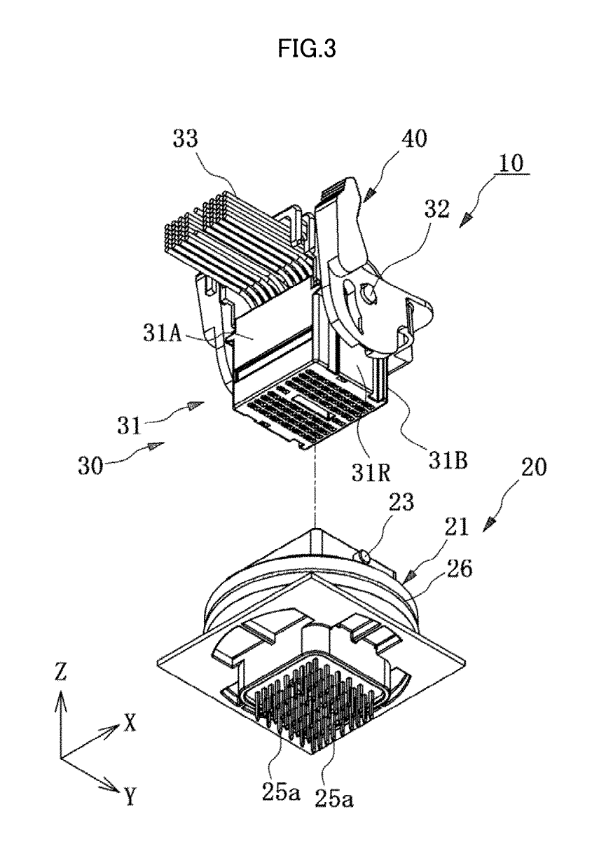

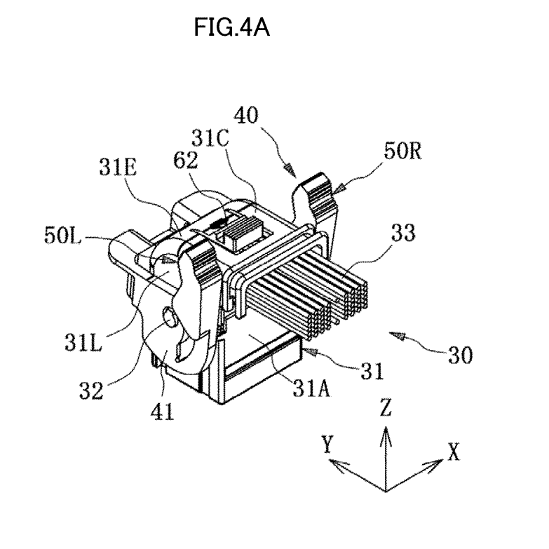

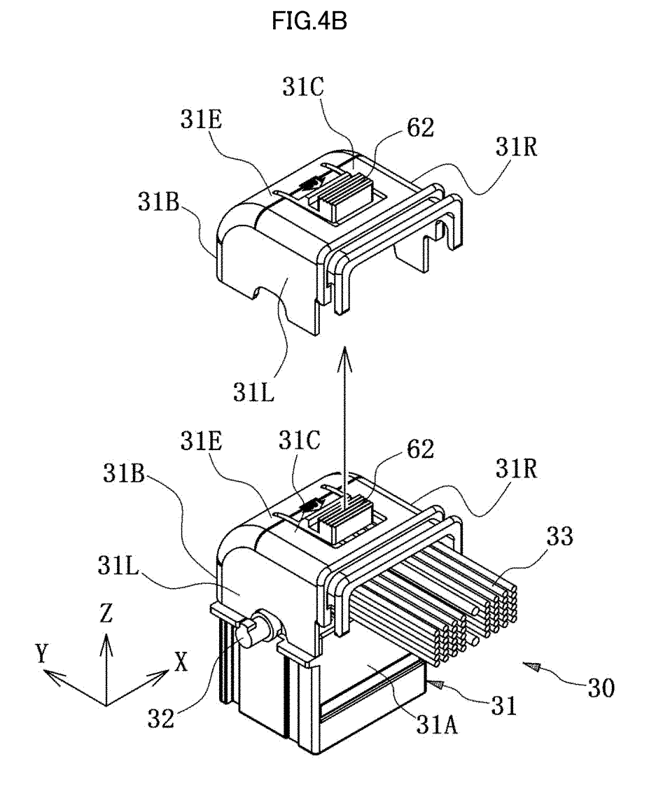

As shown in FIGS. 3 and 4A, the housing 31 includes a cable cover that protects a cable 33 by covering the cable 33. As illustrated in FIG. 4B, the cable cover includes side faces 31R and 31L, a rear face 31B, and a top face 31C. A rounded curved face 31E is formed around the edge between the rear face 31B and top face 31C of the cable cover. A spindle 32 for rotatably supporting the lever member 40 is formed through the wall of the housing 31, the wall facing the side faces 31R and 31L of the cable cover when the cable cover is attached.

As shown in FIGS. 3 and 4A, terminals in the second connecter 30 are formed of an electrically conductive material and include female terminals. The terminals 25 in the first connector 20 are connected to the terminals in the second connector 30.

The cable 33 (electric wires) is led out from a front face 31A of the second connector 30. A core in the cable 33 is electrically connected to the terminal in the second connector 30. As illustrated in FIG. 5, the cable 33 is led out to the space S, which is situated on the front side (the−Y side) with respect to the front face 31A.

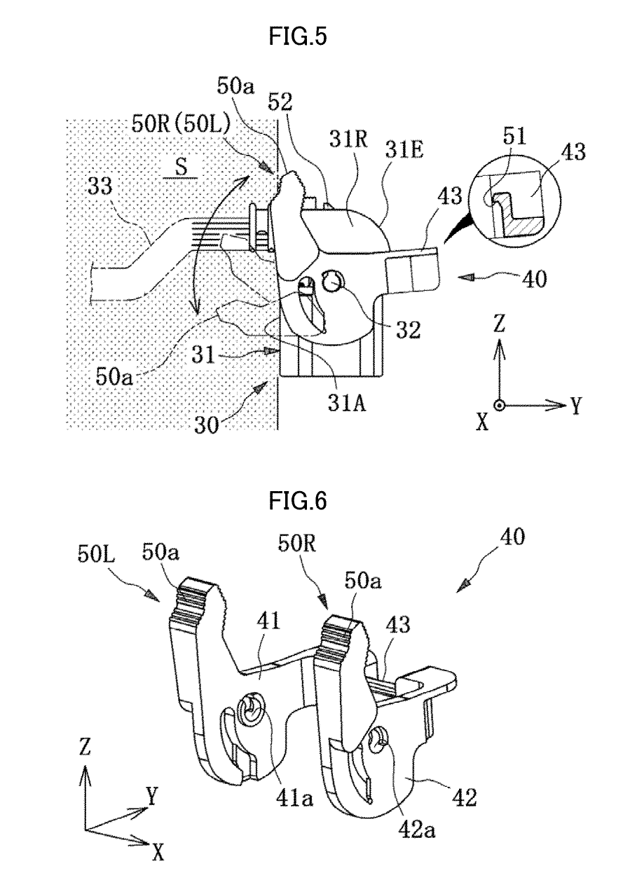

As seen in FIG. 1, the lever member 40 is used for fitting the first and second connectors 20 and 30 together by rotating on the second connector 30 from an initial position to a final fitting position. The lever member 40 is rotatably attached to the second connector 30. As illustrated in FIG. 6, the lever member 40 includes a body and a pair of operating parts 50R and 50L contiguous to the body.

The body includes a first body 41, a second body 42, and a joint 43.

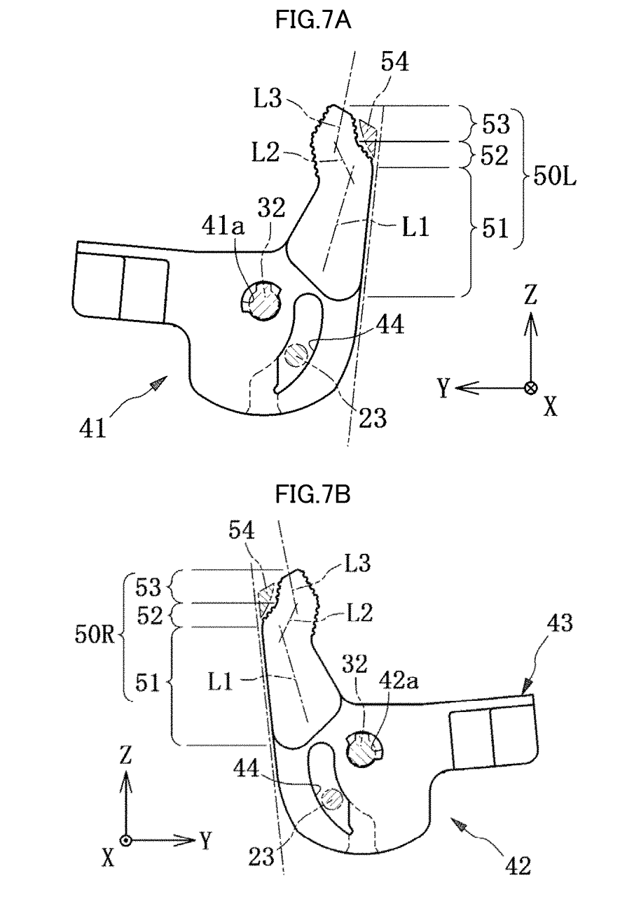

As seen by referring to FIGS. 4A and 6, the first body 41 is disposed on the side face 31L of the housing 31 in the second connector 30, in parallel with a YZ plane. As illustrated in FIG. 7A, the first body 41 includes a hole 41a and a cam groove 44, the hole 41a passing through the first body 41 in the X-axis direction, and the cam groove 44 being in an arc shape. The spindle 32 of the second connector 30 is inserted into the hole 41a. The cam pin 23 is inserted into the cam groove 44.

As seen by referring to FIGS. 4A and 6, the second body 42 is symmetrically formed with respect to a YZ plane, and disposed on the side face 31R of the housing 31 in the second connector 30, in parallel with a YZ plane. As illustrated in FIG. 7B, the second body 42 includes a hole 42a and a cam groove 44, the hole 42a passing through the second body 42 in the X-axis direction, and the cam groove 44 being in an arc shape. The spindle 32 of the second connector 30 is inserted into the hole 42a. The cam pin 23 is inserted into the cam groove 44.

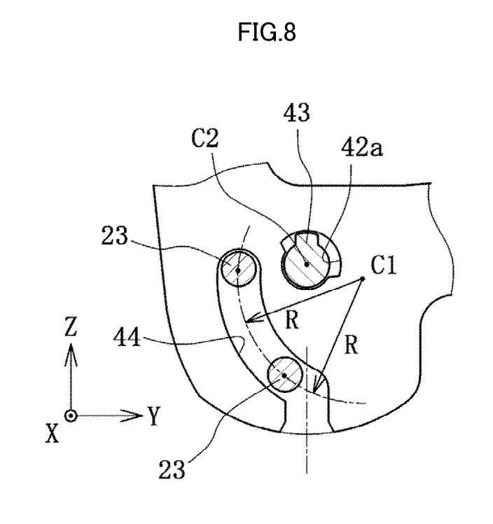

As illustrated in FIG. 8, the cam groove 44 includes a straight groove portion formed at the entry of the groove and a curved groove portion formed behind with a constant radius of curvature R. The curved groove portion of the cam groove 44 is formed so that its center C1 is not in common with the center C2 of the spindle 32.

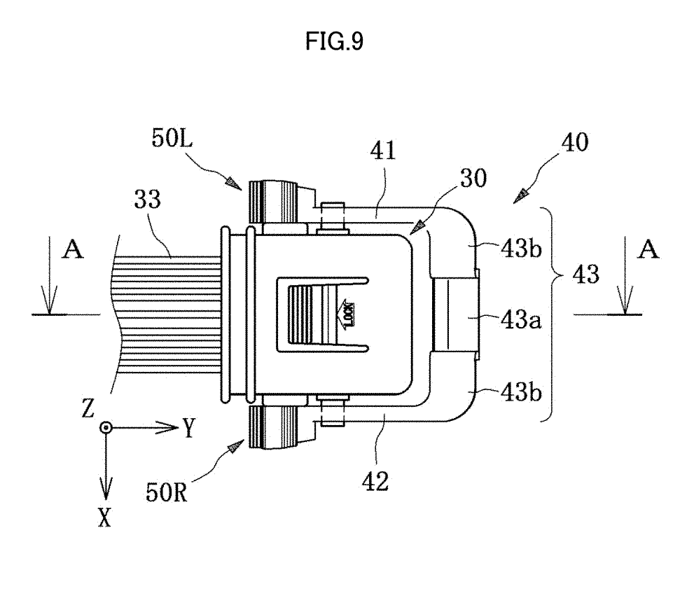

As illustrated in FIG. 9, the joint 43 is a part joining the first and second bodies 41 and 42. Specifically, the joint 43 connects one end of the first body 41 on the+Y side to one end of the second body 42 on the+Y side. The joint 43 also serves as an operating part for rotating the lever member 40. Note that the joint 43 includes a center 43a and ends 43b, any one of which can serve as an operating part.

As illustrated in FIG. 5, the operating part 50R, 50L is a part for rotating the lever member 40. In Embodiment 1, the lever member 40 includes two operating parts 50R and 50L, the operating part 50L (first part) extending from the first body 41 and the operating part 50R (second part) extending from the second body 42. The operating part 50R, 50L is configured so that, when the lever member 40 is rotated, its tip 50a moves through the space S, which is situated on the front side (the−Y side) with respect to the front face 31A of the second connector 30.

As illustrated in FIG. 6, the operating parts 50R and 50L are formed to be symmetrical with respect to a YZ plane. A slip preventer including a plurality of non-slippery grooves is disposed on the tip 50a of each of the operating parts 50R and 50L.

As illustrated in FIGS. 7A and 7B, the operating parts 50R and 50L each include a base end 51, a first tip 52, and a second tip 53.

The base end 51 is formed to protrude in a protruding direction L1 from either of the first and second bodies 41 and 42. The first tip 52 is formed to protrude from the base end 51 in a protruding direction L2, which is different from the protruding direction L1. The second tip 53 is formed to protrude from the first tip 52 in a protruding direction L3, which is different from the protruding direction L2. In Embodiment 1, the protruding direction L2 is inclined from the protruding direction L1 toward the+Y side, while the protruding direction L3 is approximately the same as the protruding direction L1. As a result, the tip 50a of the operating part 50R, 50L is formed into a shape raising from the base end 51 and then extending, creating an empty space 54 on the lower side (the−Y side) of the tip 50a of the operating part 50R, 50L.

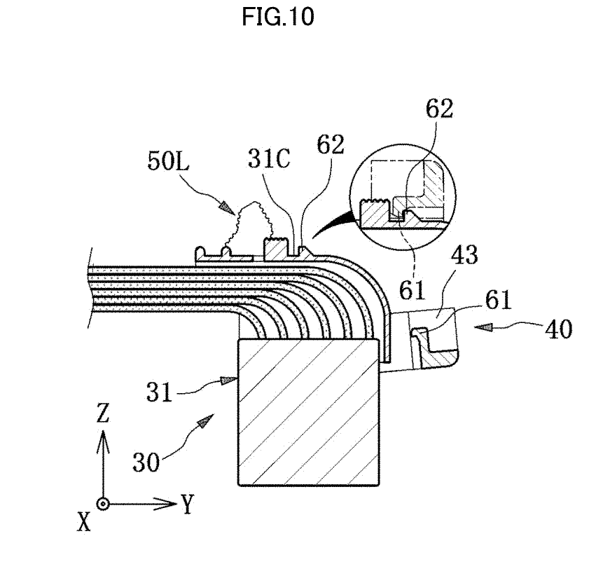

As illustrated in FIG. 10, the locking mechanism is used for locking the rotate lever member 40 to prevent the lever member 40 from rotating in the opposite direction. The locking mechanism includes a locking part 61 and a locked part 62 that is to be caught by the locking part 61.

The locking part 61 is disposed on the joint 43 of the lever member 40.

The locked part 62 is formed on the top face 31C of the cable cover for the second connector 30.

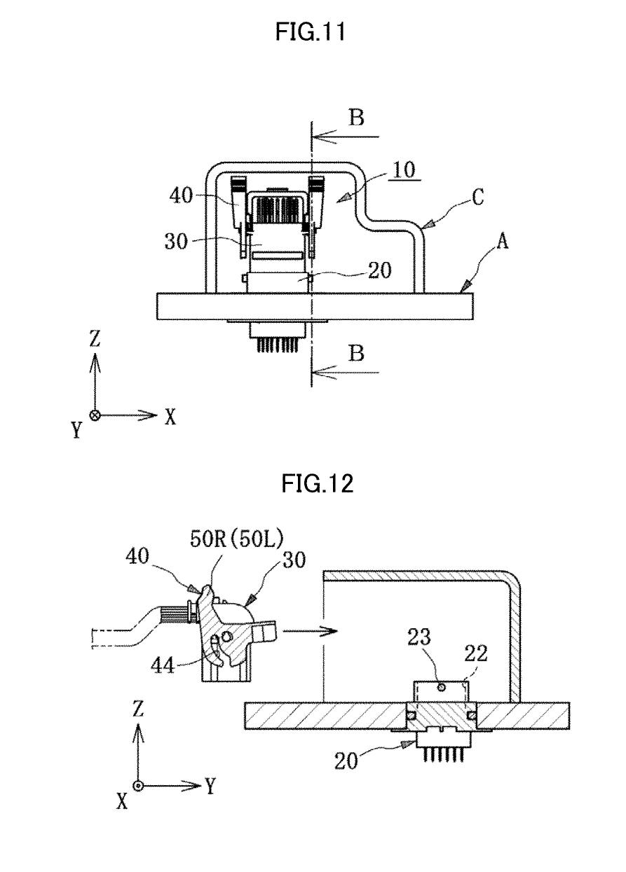

The following describes how the first and second connectors 20 and 30 of the lever-type connector 10 that are configured as above are fitted together, referring to FIGS. 11 to 16. The following description assumes that the fitting operation is performed with the lever member 40 surrounded by, for example, an outer frame C having a relatively small internal space as shown in FIG. 11. The outer frame C may be, for example, a harness cover for protecting the lever-type connector 10. The lever member 40 is attached to the second connector 30 in advance, and then the fitting operation is performed on the lever-type connector 10.

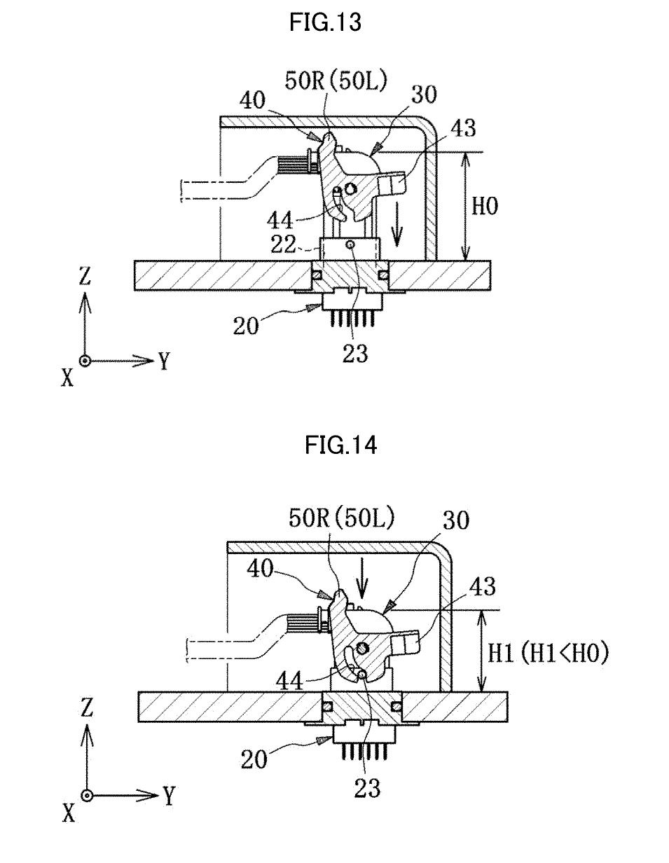

First, as illustrated in FIG. 12, the operator holds the second connector 30 in his/her hand with the lever member 40 attached thereto, and then inserts the second connector 30 into the outer frame C from its opening. Then, as illustrated in FIG. 13, the operator inserts the bottom end (the end on the−Z side) of the second connector 30 downward (from the+Z side) into the fitting hole 22 in the first connector 20.

As the operator inserts the second connector 30 into the fitting hole 22 in the first connector 20 downward (from the+Z side), the second connector 30 becomes fitted into the fitting hole 22, while the cam pin 23 in the first connector 20 enters the cam groove 44, as illustrated in FIG. 14. Upon entry of the cam pin 23 into the cam groove 44, the second connector 30 is preliminarily caught by the first connector 20. At this point of time, the lever member 40 is at its initial position before rotation.

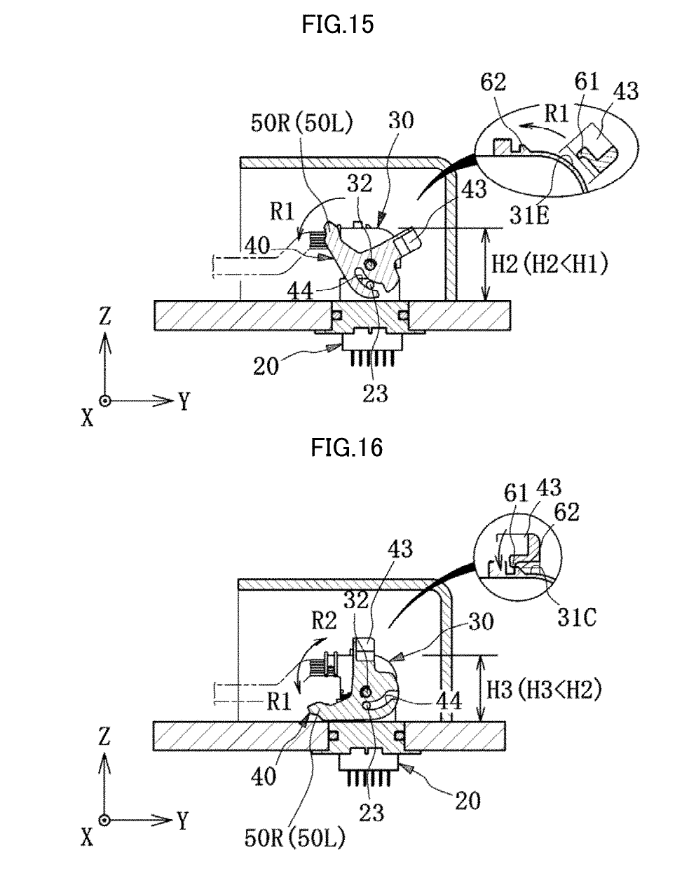

Next, as illustrated in FIG. 15, the operator rotates the lever member 40 on the second connector 30 in a rotating direction R1 by, for example, operating the operating parts 50R and 50L of the lever member 40 with his/her fingers. During this operation, the lever member 40 rotates around the spindle 32 while the joint 43 moves along the curved face 31E of the cable cover for the second connector 30.

As the lever member 40 rotates around the spindle 32, the locking part 61 in the locking mechanism comes into abutment with the locked part 62, which is formed on the top face 31C of the cable cover for the second connector 30, as illustrated in FIG. 16. Then, the locking part 61 goes beyond the locked part 62 and becomes retained on the locked part 62. As a result, the lever member 40 is locked and disabled to rotate in an opposite direction R2. The first and second connectors 20 and 30 are now completely fitted together. At the same time, terminals are connected between the first and second connectors 20 and 30.

As described above, in Embodiment 1, as illustrated in the FIG. 5 the operating part 50R, 50L is configured so that, when the lever member 40 is rotated, its tip 50a moves through the space S, which is situated on the cable 33 side with respect to the front face 31A of the second connector 30. This makes it easier to operate the lever for fitting the first and second connectors 20 and 30 together.

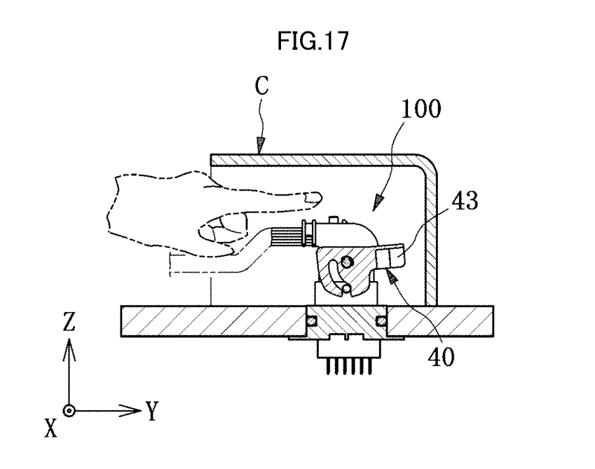

For example, in the case of the connector 100, which has no operating part 50R nor 50L, the joint 43 is used as an operating part for rotating the lever member 40. Depending on the environment where the connector 100 is installed, the user may have difficulty in inserting his/her hand or finger to use the joint 43 as an operating part, failing to rotate the lever because of interference caused by the outer frame C or any other member, as illustrated in FIG. 17.

In contrast, in Embodiment 1, the tip 50a of the operating part 50R, 50L moves through the space S, as illustrated in FIG. 5. Since the space S contains the wired cable 33, in general no other member is likely to be placed in the space. This makes it easier to operate the lever for fitting the first and second connectors 20 and 30 together. As a result, operability of the lever member 40 can be improved.

Furthermore, in Embodiment 1, a slip preventer including a plurality of grooves is disposed on the tip 50a of the operating part 50R, 50L, as illustrated in FIG. 6. This makes the operating part 50R, 50L less slippery for the user to touch with his/her hand or finger. Hence, the lever can be operated more easily for fitting the first and second connectors 20 and 30 together. As a result, operability of the lever member 40 can be improved.

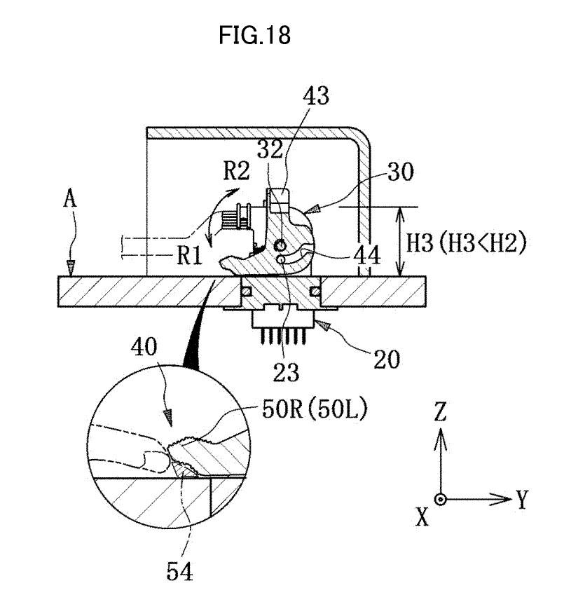

In addition, in Embodiment 1, the first tip 52 of the operating part 50R, 50L is formed to protrude in the protruding direction L2, which is different from the protruding direction L1 of the base end 51, as illustrated in FIGS. 7A and 7B. Thus, as illustrated in FIG. 18, the tip 50a of the operating part 50R, 50L is formed into a shape raising from the base end 51 and then extending, creating the empty space 54 on the lower side (the−Y side) of the tip 50a of the operating part 50R, 50L. As a result, the lever can be operated more easily for fitting the first and second connectors 20 and 30 together, even when any other member is placed near the operating part 50R, 50L. Eventually, operability of the lever member 40 can be improved.

Furthermore, in Embodiment 1, the connector includes, in addition to the operating parts 50R and 50L, the joint 43 that can be used as an operating part to rotate the lever member 40, as illustrated in FIG. 9. Hence, according to how the lever-type connector is installed, the user can select either the operating part 50R, 50L or the joint 43 serving as an operating part to rotate the lever member 40. As a result, operability of the lever member 40 can be improved.

An embodiment of the present disclosure has been described above, but the present disclosure is not limited to the foregoing embodiment.

For example, in Embodiment 1, the slip preventer formed on the tip 50a of the operating part 50R, 50L includes a plurality of grooves. However, this is not restrictive. Any other slip preventer may be used as long as a higher coefficient of friction against a hand or finger of the user can be obtained. For example, the slip preventer may include only one groove or may be formed into bumps and dips. Furthermore, a pearskin finish may be given to the surface, or a member made of a material having a high coefficient of friction against a hand or finger of the user may be attached to the surface.

### Embodiment 2

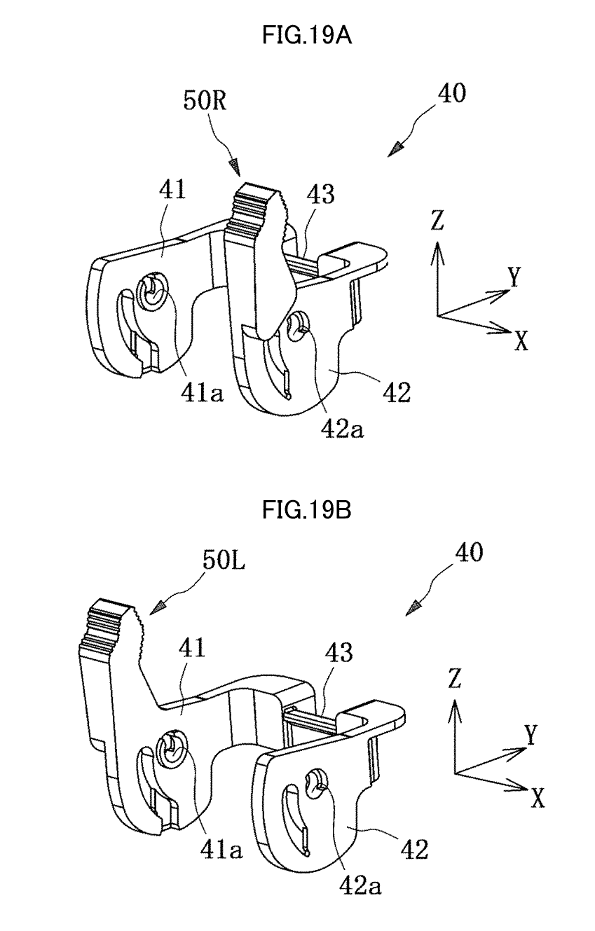

The lever member 40 according to the foregoing Embodiment 1 includes two operating parts 50R and 50L, as illustrated in FIG. 6. However, this is not restrictive. As in Embodiment 2 illustrated in FIG. 19A, the lever member may include the operating part 50R only, without the operating part 50L. Alternatively, as in a variation of Embodiment 2 illustrated in FIG. 19B, the lever member may include the operating part 50L only, without the operating part 50R. However, from the viewpoint of operability of the lever member 40, the lever member 40 preferably includes two operating parts 50R and 50L as in the foregoing Embodiment 1.

### Embodiment 3

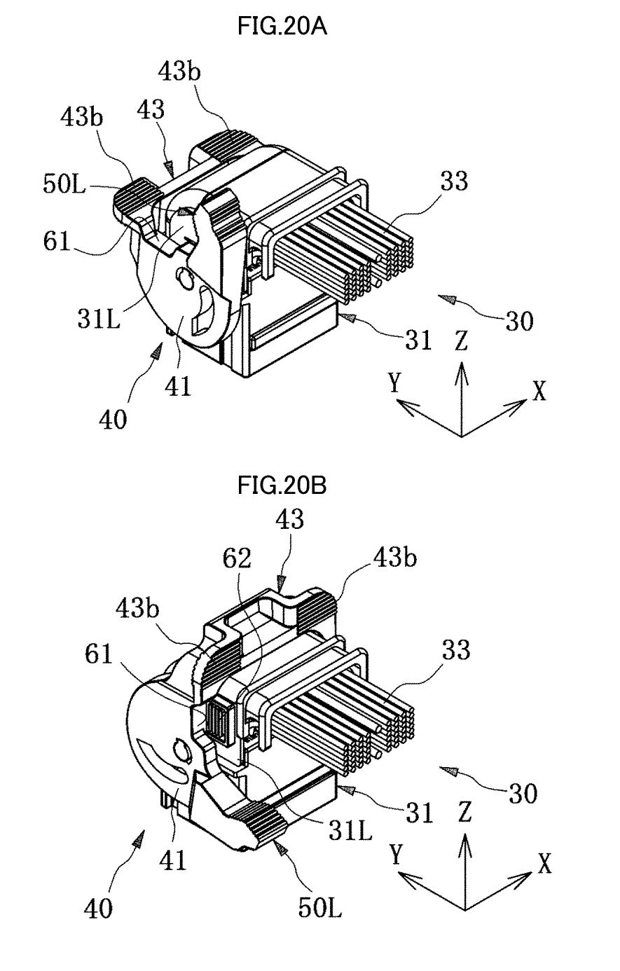

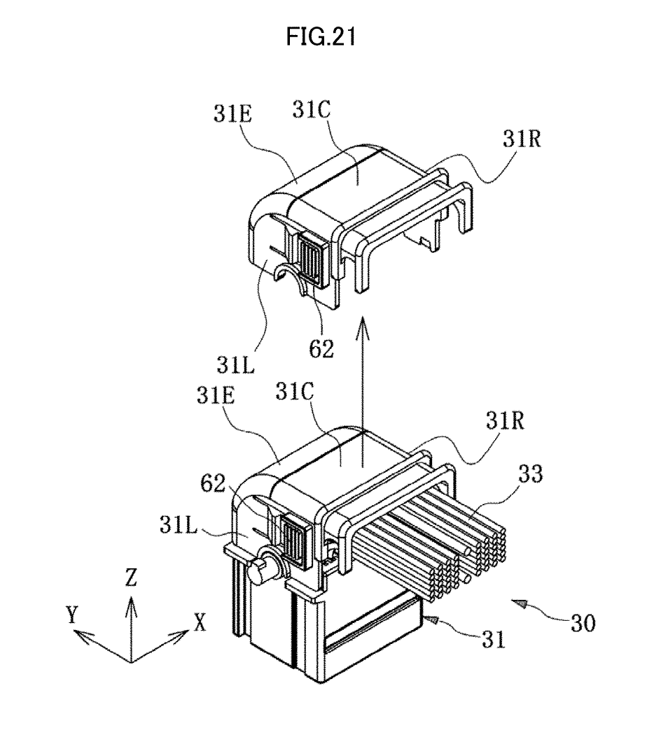

In the foregoing Embodiment 1, the locked part 62 in the locking mechanism is formed on the top face 31C of the cable cover for the second connector 30 as illustrated in FIG. 4A. However, this is not restrictive. The locked part 62 may be formed on the side face 31L of the cable cover, as in Embodiment 3 illustrated in FIGS. 20A, 20B, and 21. In this case, the locking part 61 in the locking mechanism is formed on the first body 41 of the lever member 40.

In addition, an operating face to be touched by the user during operation may be formed on both ends 43b of the joint 43. Furthermore, a slip preventer including a plurality of grooves is preferably disposed on the operating face. The joint 43 can be used as an operating part for rotating the lever member 40 by pressing the joint 43 with a finger. Note that the operating face may be applied to embodiments and variations other than Embodiment 3. The operating face is formed on every end 43b of the joint 43 in Embodiment 3, but this is not restrictive. Any number of operating faces may be formed on any locations. For example, the operating face may be formed on the back of each operating face depicted in FIGS. 20A and 20B, or may be formed on both of the front and back faces.

The locked part 62 is formed on the side face 31L in Embodiment 3, but this is not restrictive. The locked part 62 may be formed on the side face 31R, or may be formed on both of the side faces 31R and 31L. In the latter case, the lever-type connector 10 includes two locking mechanisms.

### Embodiment 4

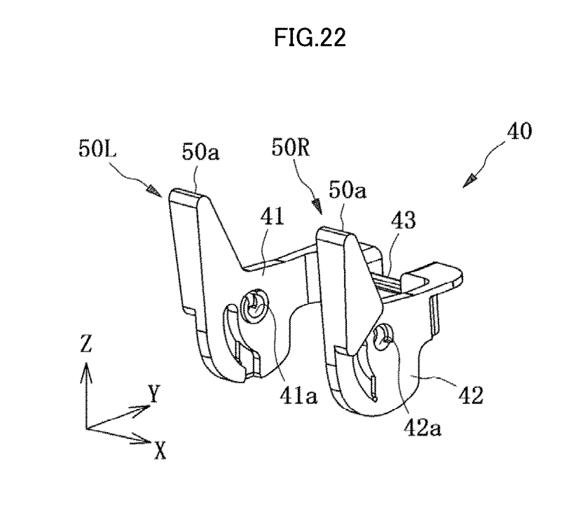

In the foregoing Embodiment 1, a slip preventer is disposed on the tip 50a of the operating part 50R, 50L, as illustrated in FIG. 6. However, this is not restrictive. The operating part 50R, 50L may have no slip preventer disposed on the tip 50a, as in Embodiment 4 illustrated in FIG. 22. Alternatively, a slip preventer may be disposed over the whole area of the operating part 50R, 50L. Other Embodiments

In the foregoing Embodiment 1, the tip 50a of the operating part 50R, 50L is formed into a shape raising from the base end 51 and then extending, creating the empty space 54 on the lower side (the−Y side) of the tip 50a of the operating part 50R, 50L, as illustrated in FIG. 18. However, this is not restrictive. The tip 50a of the operating part 50R, 50L may not necessarily be formed into a shape raising from the base end 51 and then extending, as in Embodiment 4 illustrated in FIG. 22.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A lever-type connector comprising:
a first connector that comprises a cam pin;
a second connector that is connected to an electric wire and is fitted to the first connector; and
a lever member that comprises:
a body in which a cam groove is formed, wherein the cam pin is to be inserted into the cam groove; and
an operating part that is contiguous to the body and is intended for performing a rotating operation,
wherein the lever member is rotatably attached to the second connector and causes the first connector and the second connector to be fitted together by rotating from an initial position to a final fitting position, and
wherein the operating part is configured so that, when the lever member is rotated, a tip of the operating part moves through a space, which is situated on the electric wire side with respect to an end face of the second connector from which the electric wire is led out.

2. The lever-type connector according to claim 1, wherein a slip preventer for preventing a slip is disposed on at least a tip of the operating part.

3. The lever-type connector according to claim 2, wherein the slip preventer comprises a plurality of grooves.

4. The lever-type connector according to claim 1, wherein the operating part comprises:
a base end that protrudes from the body of the lever member; and
a tip that protrudes from the base end in a direction different from a direction in which the base end protrudes.

5. The lever-type connector according to claim 1, wherein the body comprises:
a first body and a second body, in at least one of which the cam groove is formed; and
a joint that connects the first body and the second body.

6. The lever-type connector according to claim 5, wherein the operating part comprises:
a first part that extends from the first body; and
a second part that extends from the second body.

7. The lever-type connector according to claim 5, wherein the operating part comprises:
a part that extends from the first body.

8. The lever-type connector according to claim 5, comprising a locking mechanism that includes:
a locking part that is disposed on the joint; and
a locked part that is to be caught by the locking part and is disposed on the second connector.

9. The lever-type connector according to claim 5, comprising a locking mechanism that includes:
a locking part that is disposed on the first body; and
a locked part that is to be caught by the locking part and is disposed on the second connector.

10. The lever-type connector according to claim 8,
wherein the second connector comprises a cover that covers the electric wire, and
wherein the locked part is disposed on the cover.
